(19) United States
(12) Patent Application Publication
(10) Pub. No.: US 2013/0246652 A1
(43) Pub. Date: Sep. 19, 2013

(54) Discover IPv4 Directly Connected Host Conversations Using ARP in Distributed Routing Platforms

(71) Applicants: Fangping Liu, San Jose, CA (US); Ming Zhang, San Jose, CA (US)

(72) Inventors: Fangping Liu, San Jose, CA (US); Ming Zhang, San Jose, CA (US)

(73) Assignee: Cisco Technology, Inc., San Jose, CA (US)

(21) Appl. No.: 13/422,155

(22) Filed: Mar. 16, 2012

(51) Int. Cl. G06F 15/173

(52) U.S. Cl. 709/238

(57) ABSTRACT

Systems and methods are provided to enhance the ARP software implementation. Conversational Directly Connected Host routes may be discovered and used to implement conversational forwarding which improves hardware scalability.

### BACKGROUND

There exists a need for discovering conversational DCH routes with address resolution protocol (ARP) protocol enhancement when hosts are connected to vlan switch/trunk ports.

### BRIEF DESCRIPTION OF THE DRAWINGS

The accompanying drawings, which are incorporated in and constitute a part of this disclosure, illustrate various embodiments. In the drawings:

FIG. 1 illustrates an example network environment for embodiments of this disclosure;

FIG. 2 is a flow chart illustrating embodiments of this disclosure;

FIG. 3 is a flow chart illustrating embodiments of this disclosure; and

FIG. 4 is a block diagram of a computing network device.

### DESCRIPTION OF EXAMPLE EMBODIMENTS

### Overview

Consistent with embodiments of the present disclosure, systems and methods are disclosed for discovering conversational DCH routes with address resolution protocol (ARP) protocol enhancement when hosts are connected to vlan switch/trunk ports.

It is to be understood that both the foregoing general description and the following detailed description are examples and explanatory only, and should not be considered to restrict the application's scope, as described and claimed. Further, features and/or variations may be provided in addition to those set forth herein. For example, embodiments of the present disclosure may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of this disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

IP routers/switches forward IP packets based on destination IP address lookup. In traditional hardware based distributed IP routing platforms, this may require IP routes to be programmed in all the line cards which make forwarding decisions. Increase in internet routes, number of directly connected IP devices and VRF routing tables naturally entail larger hardware table and bigger latency, while in certain markets, large data centers for example, customers seeks inexpensive, low-power and low latency switches for large scale deployment.

A conversation based forwarding model rather than traditional destination IP based forwarding, may be employed for directly connected hosts (DCHs) route entries (known as ARP entries in a traditional, BSD like TCP/IP stack). By implementing conversational DCH forwarding model, a distributed forward engine is a switch that programs only conversational DCH routes among all known DCH routes. Hence the way to use hardware route table is changed, and in many deploy scenarios scalability can be improved.

In a hardware based distributed forwarding architecture, each distributed forwarding device, a line card for example, has its own forwarding engine and hardware forwarding table, can make layer 3 lookups and forwarding decisions. Any IP devices, including servers, hosts, or routers, which are directly connected to the line card, are refer to as directly connected hosts (DCHs) to the switch in this draft. DCH route entries may be discovered and learned through ARP protocol by the switch.

In deployment scenarios where a large number of IP devices are directly connected to the switch, each line card would connect to a subset of the IP devices. In typical routing/switching platforms, all directly connected hosts (DCH) after being learned through ARP are installed in hardware tables of all line cards, even though not all line cards are directly connected to all the DCHs. Otherwise IP connectivity may not be achieved for DCHs not installed in hardware.

To improve scalability in such scenarios, conversational IP routes may be employed in present embodiments. To a line card, a conversational IP route is a route that is needed to forward packets which the line card encountered within a defined time period.

Embodiments of the present disclosure, specifically address the directly connected host routes for the switch. ARP entries of hosts directly connected to a line card are conversational DCH routes to the line card, because the line card needed or needs to send IP packets to those hosts. For ARP entries of hosts not directly connected to a line card (even though they are directly connected to other line cards of the switch), there are no conversational routes for the line card to begin with. When the line card had packets within a certain period, or has packets to send to those hosts, then they become conversational routes to the line card.

A DCH route conversation can be represented as (line card index, DCH IP address). The DCH IP address may be qualified with a line card index which is globally known and unique within the switch. When there are multiple line cards having conversations with a DCH, the route entry has multiple line card conversations and hence has multiple conversation objects.

When installing DCH routes to hardware table, a line card may only install those DCH routes which are conversational routes to the line card. In other words, the line card may only install a DCH route if the route has a conversation object whose line card index matches with index of the line card. This way, in scenarios where each line card is not talking to all hosts directly connected to the switch at the same time, saving in hardware routing table may still be achieved and scalability is improved.

The conversational DCH entries in hardware tables, as well as conversation objects in software, need to be periodically aged out to prevent old conversational DCH entries from accumulating. This can be achieved by monitoring traffic statistics on the conversational DCH routes in a hardware table. A max_quiet_time variable may be configured, which specifies the maximum time a conversational route can stay in hardware table without forwarding any packets. Each conversation object in software can have a timer associated with it, while each line card can poll traffic statistics periodically and report to some software module which maintains the conversational objects. When a statistics counter for a conversational route stays the same for max_quiet_time, the software module instructs the line card to remove the conversational route state from hardware table, and purge the conversation object from the DCH route.

In hardware based distributed forwarding router/switches, to implement conversational forwarding, conversational directly connected host (DCH) routes need to be discovered and managed for hardware table programming. ARP protocol can be enhanced to achieve conversational DCH routes discovery. Embodiments of the present disclosure apply for hosts which are connected to the switch through vlan switch ports or trunk ports.

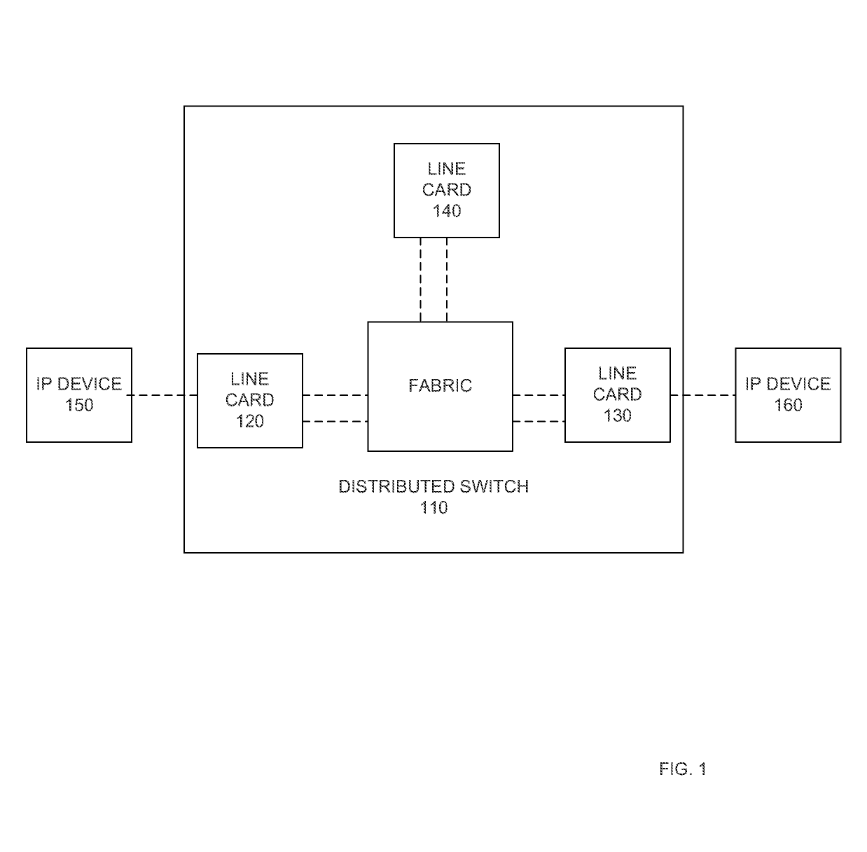

FIG. 1 illustrates an operating environment for embodiment of the present disclosure. A distributed switch 110 may have three line cards, such as line card 120, line card 130, and line card 140. In some embodiments, these may not take the form of a line card, but could be independent hardware devices connected through switch fabric links or any other form, and managed by a common control plane software instance. However, for purposes of illustration the concept of line cards is used in this discussion.

IP device 150 may be an IP network device connected to line card 120 front port, IP device 160 may be an IP network device connected to line card 130 front port. Here, IP device 150 and IP device 160 are directly connected hosts for distributed switch 110, while IP device 150 may be a local DCH for line card 120 but not for line card 130 and line card 140.

Assume in the beginning the distributed switch does not know IP device 150 in its ARP table. When IP device 150 tries to talk to IP device 160, it first resolves ARP associated with distributed switch 110 IP address and sends a data packet to line card 120. Line card 120 may detect that the destination IP of IP device 160 is on a connected interface without MAC information. This may trigger ARP to resolve the IP device 160 MAC. After IP device 160 is ARP resolved, software may create a conversation identified by (line card 120, IP address (IP device 160)). The conversation may then be associated with the IP device 160 route entry. When there are additional line cards talking to IP device 160, there will be created a list of conversations for IP device 160.

If an ARP entry for IP device 160 already exists in distributed switch 110 ARP table, when line card 120 first receives a packet in hardware destined to IP device 160, line card 120 will not know IP device 160 because the IP device 160 route entry is not installed in its hardware table (line card 120 has had no conversation with IP device 160). As such, embodiment of software in the present disclosure may create a conversation object (line card 120, IP address (IP device 160)). The conversation object may then be associated with the existing IP device 160 ARP entry. In some embodiments, the packet can also be one of a plurality of fragments of an IP packet.

When the IP device 160 route entry is created or updated in software due to conversation activities, an attempt may be made to download the IP device 160 route entry to all line cards for hardware programming. The software component that handles hardware programming may examine the conversation objects to decide whether to program it for a certain line card. In the present example, line card 130 may be the egress line card which directly connects to destination host IP device 160. As such, line card 130 needs to have the host route entry programmed. In some embodiments of the present disclosure, line card 120 will install an IP device 160 entry since IP device 160 has a conversation involving line card 120. Line card 130 may also install an IP device 160 entry. Conversely, line card 140 will not install an IP device 160 entry in hardware table because there is no conversation between LC3 and IP device 160.

ARP as a software component may be centralized on one CPU, or in some embodiments, ARP can be distributed among multiple CPUs. Distributed switch 110 may have multiple CPUs to perform control plane and management functionalities, or it may have just one CPU to do that.

The interface connecting IP device 150 and line card 120 can take various forms. In some embodiments, it can be a routed interface, a switching port/vlan trunk port as part of a switch virtual interface (SVI), or a member of a distributed link aggregation group (LAG) which is part of SVI or has IP address(es). In the former non-LAG cases, the first part of the conversation object key (line card 120, IP address (IP device 160)) for the line card 120, is straightforward and can be performed as a card index which in hardware identifies line card 120 and which has the routed interface or switch port/trunk port as identified local front port.

In the distributed LAG case, the LAG itself may have an ID to identify the LAG in hardware. In some embodiments of the present disclosure, the LAG ID can be used as the first part of the key, so the key will look like (LAG_ID, IP address (IP device 160)). And the IP device 160 host entry need to be installed on all ingress line cards which has ports as part of the same LAG. In other words, if one ingress line card has conversation with a IP device 160 through a LAG as incoming interface, all ingress line cards which have member ports of the LAG are considered as having conversation to IP device 160.

Here the first field of the key, be it either LC_ID or LAG_ID, can take the form of any identifier that have one to one mapping relationship with the hardware indexes that are used to identify the line card or LAG in hardware. Since IP device 160 is a directly connected host, there will be only one layer 3 interface connecting IP device 160 to the switch, meaning there is no multi-path.

The interface connecting IP device 160 and line card 130 could also take any of the forms mentioned above. When interface p2 is a routed interface, or member of a LAG, ingress line cards could program only the interface subnet prefix entry to cover all hosts of that subnet which p2 is associated with, to direct traffic to the specific port or LAG learned through ARP; ingress line cards do not need to have those host route entries in hardware. When interface p2 is a switch port/vlan trunk port of a vlan, different hosts connected to this vlan could span multiple line cards; then ingress line cards need to have IP device 160 route entry programmed in hardware in order to instruct hardware to forward traffic destined to IP device 160 to a specific line card learned through ARP. In this case the ingress line cards which need to program IP device 160 route entry need to know to forward the packets to the egress port or line card though which the ARP was learned.

With this approach, a line card will only install DCH route entries for hosts which this line card has conversation with, and only those hosts that are connected to the switch through vlan interfaces. All other DCH entries will not be installed in hardware of ingress line cards, this greatly reduces requirements on hardware table size, and improves hardware as well as network scalability.

The conversational DCH entries in hardware tables, as well as conversation objects in software, need to be aged out to prevent old conversational DCH entries from accumulating. This can be achieved by monitoring activities (or traffic statistics) on the conversational DCH entries. For example, line card 120 may install an IP device 160 entry as a conversational DCH entry. Line card 120 may then periodically poll statistics of this entry. If no source sends traffic towards IP device 160 through line card 120, this entry will stay quiet (packet counter stays the same) for a configured period and line card 120 can purge the IP device 160 entry. Line card 120 may also send updates to interested software modules to purge the conversation (line card 120, IP address (IP device 160)) from an IP device 160 conversation inventory in software.

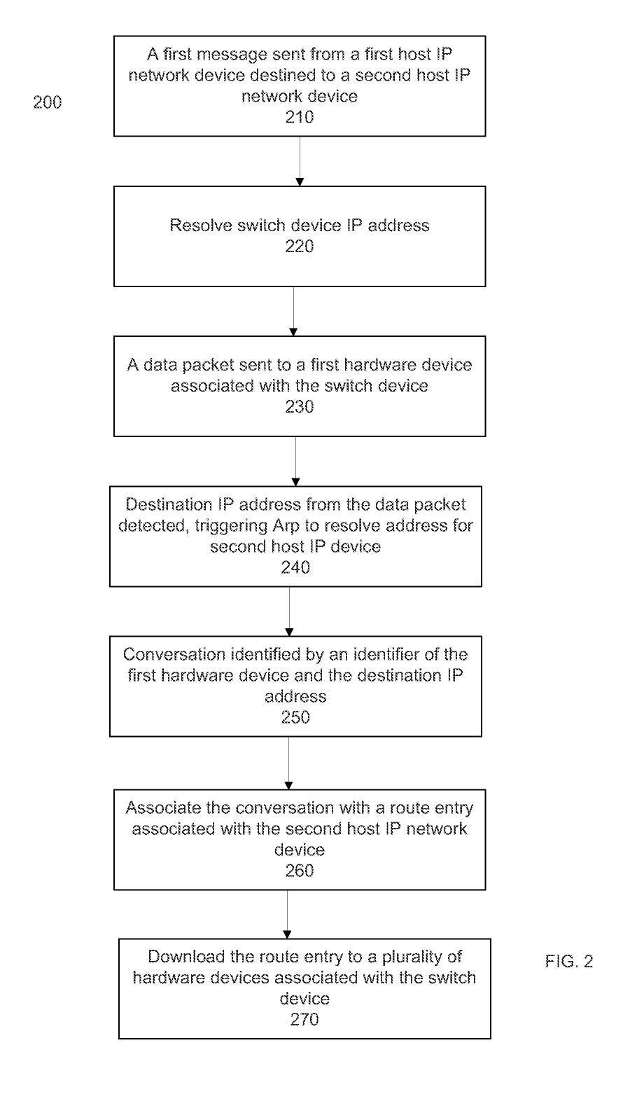

FIG. 2 is a flow chart illustrating embodiments of this disclosure. Method 200 may begin at step 210 where a first message may be sent from a first host IP network device destined to a second host IP network device. The first host IP network device and the second host IP network device may be connected to the same switch device.

In some embodiments, the host IP network devices may be connected to the switch device through vlan switch ports or trunk ports. In some embodiments, the switch device is a distributed fabric switch device comprising a plurality of connected hardware devices. The hardware devices may comprise line cards. Furthermore, the plurality of hardware devices may include at least an egress hardware device directly connected with the second host IP network device. The hardware devices may be managed by common control plane software.

Method 200 may continue to step 220. At step 220, an ARP entry associated with the switch device IP address may be resolved. Once the ARP entry has been resolved, method 200 may proceed to step 230 where a data packet may be sent to a first hardware device associated with the switch device. In some embodiments, the data packet is one of a plurality of fragments from an IP packet.

At step 240 the destination IP address from the data packet may be detected, triggering ARP to resolve a MAC address associated with the second host IP network device. Method 200 may then proceed to step 250 where a conversation identified by an identifier of the first hardware device and the destination IP address may be created.

Next, at step 260 the conversation may be associated with a route entry associated with the second host IP network device. In some embodiments, an ARP entry for the second host IP network device may be preexisting in a table associated with the switch device, in which case the conversation is associated with the preexisting ARP entry. Finally, at step 270 the route entry may be downloaded to a plurality of hardware devices associated with the switch device.

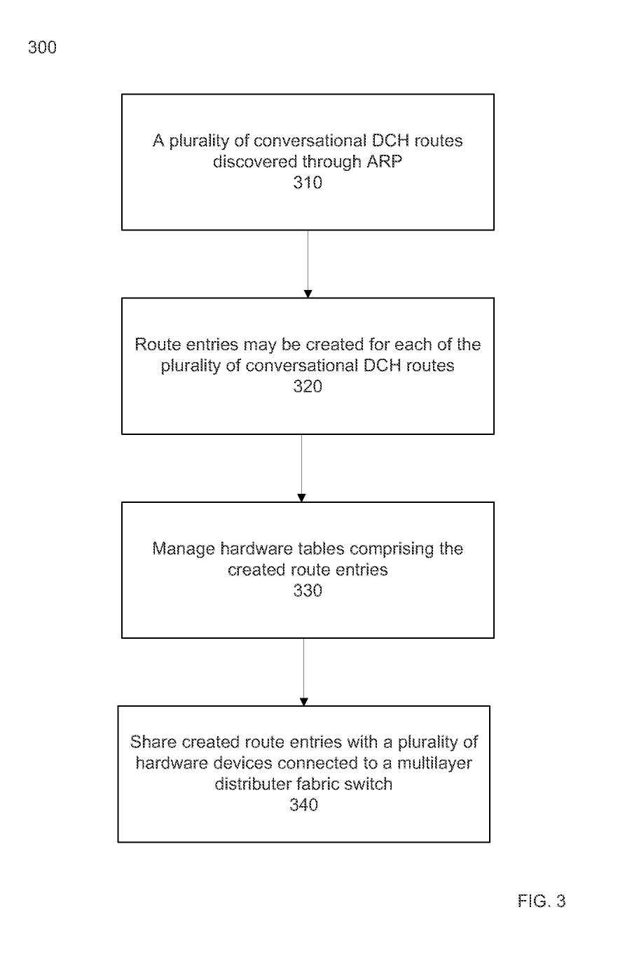

FIG. 3 is a flow chart illustrating embodiments of the present disclosure. Method 300 may begin at step 310 where a plurality of conversational DCH routes through may be discovered through ARP. Method 300 may then proceed to step 320. At step 320, route entries may be created for each of the plurality of conversational DCH routes. The route entries may then be stored in a hardware table.

At step 330, the hardware table comprising the created route entries may be managed to ensure up to date route entries. For example, route entries may be periodically purged after a predetermined period of inactivity.

Next, at step 340, the created route entries may be shared with a plurality of hardware devices connected to a multilayer distributed fabric switch device. In some embodiments of the present disclosure, the created route entries may comprise an egress hardware device IP address and at least one of: a hardware device identifier or a LAG identifier. As discusses above, the egress hardware device may be a line card.

Embodiments of the present disclosure provide many advantages over prior implementations. First, ARP protocol can be enhanced to achieve conversational DCH routes discovery. Furthermore, there is no need to change the ARP protocol definition. From the point of view of other routers/switches in the system, the distributed switch 110 employing this enhanced ARP behaves no differently with respect to ARP protocol.

As embodiments of the present disclosure propose a conversational forwarding model for distributed forwarding platforms, the ARP protocol software itself may take the distributed format to scale control plane CPU. For embodiments of the present disclosure, there is no need to modify existing switch hardware just for the sake of conversational forwarding.

The described IPv4 conversational DCH route entries may apply to hosts which are directly connected to the switch through vlan switch ports or trunk ports. In the context of only discussing directly connected hosts, each DCH host IP will only be connected to one layer 3 interface. Accordingly, there may be no equal cost multi-path (ECMP) consideration for any such host IP device.

In embodiments of the present disclosure, when a host is connected to an egress interface type of a routed interface or LAG, there is no need to install conversational DCH routes for such hosts in ingress line cards. They can be programmed in egress line card only. When a host is connected through vlan switch port or trunk port, the conversational DCH host routes may need to be programmed to ingress line cards in addition to egress line cards.

When a traffic ingress interface is a routed interface or vlan switch port/trunk port, the conversation objects key may consist of (line card ID, IP address (host device)). In some embodiment, the line card ID may comprise an index that can be used to identify a line card in hardware, or any identifier that can be mapped to such a hardware index.

When traffic ingress interface is part of LAG, the conversation key may be (LAG ID, IP address (host device)). Here the LAG ID can be an index that can be used to identify a LAG in hardware, or any identifier that can be mapped to such a hardware index. In this case, any line card which has a port as a member of this LAG is considered as having a conversation with this host, and as such may need to install the host route entry.

The ARP implementation itself can be centralized or distributed in embodiments of the present disclosure. After a host may have ARP resolved and its host route entry programmed in a certain line card, successive packets to this host entering into a line card without this host route entry will punt traffic to a software stack and trigger a query to the ARP table. Since an ARP entry already exists, the packets may lead to the creation of a new conversation object associated with this host ARP entry.

In some embodiments of the present disclosure, successive fragments of an original packet may be considered as successive packets. As such, they may be handled in the same fashion as described above with respect to ARP query/conversation creation, in addition to any legacy processing. The fragments can trigger new conversation objects, but will not be dropped.

Embodiments of the present disclosure identify/create/manage conversational DCH routes so as to manage hardware route tables efficiently. This provides a solution for an environment where the hardware table cannot scale. In a datacenter/cloud switch, due to latency consideration and die size, the hardware route table (TCAM or LPM, etc) typically has a small size. These route tables cannot hold all host routes of directly connected hosts due to their size. Present embodiments may let the ingress line card be relieved with DCH hosts connected through vlan if there is no conversation for the line cards. Those entries are installed only if there are conversations discovered.

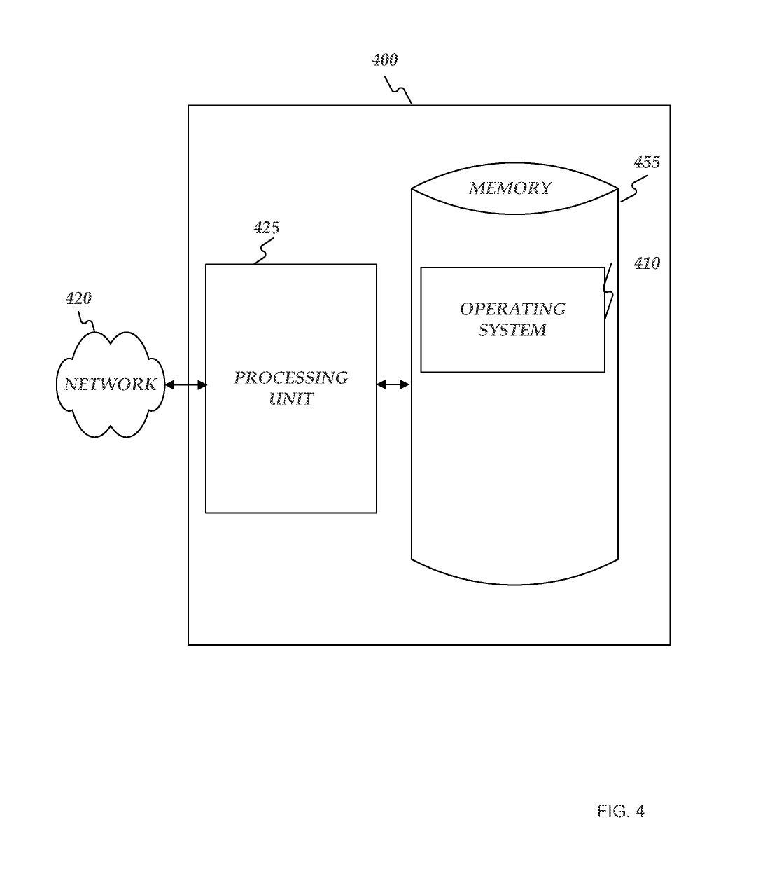

FIG. 4 illustrates a computing device 400. Computing device 400 may include processing unit 425 and memory 455. Memory 455 may include software configured to execute application modules such as an operating system 410. Computing device 400 may execute, for example, one or more stages included in the methods as described above. Moreover, any one or more of the stages included in the above describe methods may be performed on any element shown in FIG. 4.

Computing device 400 may be implemented using a personal computer, a network computer, a mainframe, a computing appliance, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

Embodiments of the present disclosure, for example, are described above with reference to block diagrams and/or operational illustrations of methods, systems, and computer program products according to embodiments of this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and are the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

What is claimed is:

1. A method for discovering a conversational DCH route comprising:
sending a first message from a first host IP network device destined to a second host IP network device, wherein the first host IP network device and the second host IP network device are connected to the same switch device, and wherein the second host IP network device is on a connected interface;
resolving an ARP entry associated with the switch device IP address;
sending a data packet to a first hardware device associated with the switch device;
detecting the destination IP address from the data packet;
triggering ARP to resolve a MAC address associated with the second host IP network device;
creating a conversation identified by an identifier of the first hardware device and the destination IP address; and
associating the conversation with a route entry associated with the second host IP network device.

2. The method of claim 1, wherein the host IP network devices are connected to the switch device through one of: vlan switch ports or trunk ports.

3. The method of claim 2, wherein the switch device is a distributed fabric switch device comprising a plurality of connected hardware devices.

4. The method of claim 3, wherein the hardware devices comprise line cards.

5. The method of claim 3, further comprising managing the hardware devices by common control plane software.

6. The method of claim 1, wherein an ARP entry for the second host IP network device is preexisting in a table associated with the switch device; and
associating the conversation with the preexisting ARP entry.

7. The method of claim 1, wherein the data packet is one of a plurality of fragments from an IP packet.

8. The method of claim 1 further comprising:
downloading the route entry to a plurality of hardware devices associated with the switch device.

9. The method of claim 8, wherein the plurality of hardware devices comprises at least an egress hardware device directly connected with the second host IP network device.

10. An apparatus comprising:
a memory; and
a processor coupled to the memory, wherein the processor is operative to:
detect a destination IP address from a data packet;
resolve a MAC address associated with a destination network device; and
create a route entry representative of a conversation identified by an identifier of an ingress hardware device and the destination IP address; and
provide the route entry to a plurality of hardware devices connected to the apparatus.

11. The apparatus of claim 10, wherein the apparatus comprises a multilayer fabric switch device.

12. The apparatus of claim 11, wherein the multilayer fabric switch device comprises an ARP software component distributed among multiple CPUs.

13. The apparatus of claim 11, wherein an interface between a host network device and the ingress hardware device comprises one of a routed interface or a switching port.

14. The apparatus of claim 11, wherein an interface between a host network device and the ingress hardware device comprises a distributed LAG.

15. The apparatus of claim 14, wherein the processor is further configured to:
create a conversation object key comprised of an identifier of the distributed LAG and the IP address of the destination network device.

16. A method comprising:
discovering a plurality of conversational DCH routes through ARP;
creating route entries for each of the plurality of conversational DCH routes; and
managing a hardware table comprising the created route entries.

17. The method of claim 16, further comprising:
sharing the created route entries with a plurality of hardware devices connected to a multilayer distributed fabric switch.

18. The method of claim 17, wherein the created route entries comprise an egress hardware device IP address and at least one of: a hardware device identifier or a LAG identifier.

19. The method of claim 18, wherein the egress hardware device is a line card.

20. The method of claim 16, further comprising:
periodically purging route entries that have aged out.
